(19) United States
(12) Patent Application Publication
(10) Pub. No.: US 2007/0203608 A1
(43) Pub. Date: Aug. 30, 2007

(54) Method for 3 dimensional textile design and a computer-readable storage medium storing a textile design program

(76) Inventor: Ki-Yong Kang, Ulsan (KR)

Correspondence Address: TROXELL LAW OFFICE PLLC, 5205 LEESBURG PIKE, SUITE 1404, FALLS CHURCH, VA, 22041, US

(21) Appl. No.: 11/583,976

(22) Filed: Oct. 20, 2006

(30) Foreign Application Priority Data
Oct. 24, 2005 (KR) 2005-0100022

(51) Int. Cl. G06F 19/00

(52) U.S. Cl. 700/133; 700/131

(57) ABSTRACT

The present invention relates to textile design, more particularly to a method and an apparatus for textile design using a three dimensional textile design program. The present invention can solve the problem of the pattern or color designed by the textile designer on two dimensional cloth being deformed in three dimensional clothes. Using the textile design program of the present invention, the textile designer may perform designing on the three dimensional clothes form, which is automatically expressed in two dimensions on a computer, making it possible to print the design and make clothes through cutting and sewing.

### TECHNICAL FIELD

The present invention relates to textile design, more particularly to a method and an apparatus for textile design using a three dimensional textile design program.

### BACKGROUND ART

A “textile” is a flexible material such as fabric or cloth used to make clothes. The whole industry starting from the fiber making to the dyeing of threads, cloths, leathers, etc. is called the textile industry and the products related with the field are called the textile products. “Textile design” is a process of giving various patterns and colors to the surface of printed cloths, fabrics, etc. in order to improve their quality and worthiness. The textile design can be said as a design process for creating and expressing the “beauty” and fashion.

The conventional textile industry is based on the mass production through textile design printing on two dimensional planes of white cloths. FIG. 1 is a flowchart illustrating the conventional process of clothes making. When a clothes maker makes a plan for a new product, a fashion designer designs the style and color of the clothes based on the intention of the planning. Subsequently, textile designing is preformed manually or using a computer based on the textile material and design intended by the fashion designer. Then, following dyeing or printing of the textile design using a digital printer, the fabric is cut and sewn into clothes.

In this manufacturing process, the textile design remains passive and dependent. Further, since the fabric design is performed in two dimensions, the textile design tends to be carried out totally entrusted to the concept and creativity of the textile designer, without sufficient consideration of the (three-dimensional) silhouette of the clothes or the intention of the fashion designer or the expectation of customers.

But, the clothes are made by cutting the printed cloths and sew them into a three dimensional form. In this process, the original textile design tends to be deformed in the actual clothes, giving different images. That is, the three-dimensional design (pattern) of the clothes may be different from the original textile design in two dimensions.

As such, the textile design and the fashion design are detached from each other, at present. And, rather than respecting the intention of the textile designer, the fashion designer has selected the pattern that he/she wants. Consequently, rather than satisfying the needs of the customers directly, the textile industry is meeting them indirectly through fashion designers.

In this situation, a fashion designer that can directly meet the needs of the customers or a system capable of expressing the textile design of the textile designer is needed.

One of the ways to attain this is to follow the traditional handicraftship. That is, by cutting out white cloth, basting it provisionally, drawing a design pattern on it, disassembling the basting, dyeing each part and sewing together the parts, the original three dimensional design intended by the designer can be realized in the clothes. Although this method can be applied to each suit, it is a process requiring a great deal of time and effort. Since the method cannot be applied to mass production using machinery and costs a lot, it cannot be seen as a system suitable for the textile design industry.

### DISCLOSURE

An object of the present invention is to solve the aforementioned problem and to provide a textile design system capable of directly expressing the intention and taste of textile designers, fashion designers and customers through textile designing on three dimensional clothes using a three dimensional textile design program.

Since the design performed using the textile design system can be printed using a digital printer in the form that can be cut or sewn just as it is, the design can be produced in large quantity.

### DESCRIPTION OF DRAWINGS

FIG. 1 is a flowchart illustrating the conventional clothes making process.

FIG. 2 is a flowchart illustrating the clothes making process in accordance with the present invention.

FIGS. 3a to 3d are drawings illustrating the basic principle of the three dimensional textile design in accordance with the present invention.

FIG. 4 is a flowchart illustrating the textile design process in accordance with the present invention.

FIGS. 5a to 5f are drawings illustrating the textile design process performed on a computer in accordance with the present invention.

FIGS. 6 to 10 are drawings illustrating another example of clothes making using the textile design program in accordance with the present invention.

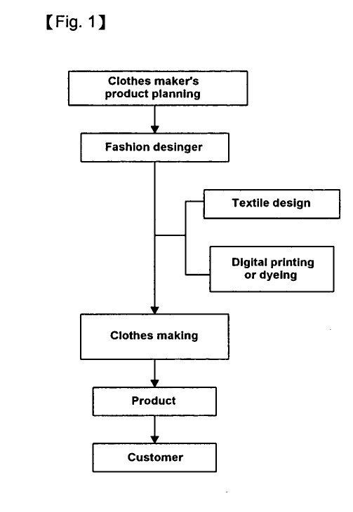

### BEST MODE

Hereinafter, the method and apparatus for three dimensional textile design in accordance with the present invention will be described in detail with reference to the accompanying drawings.

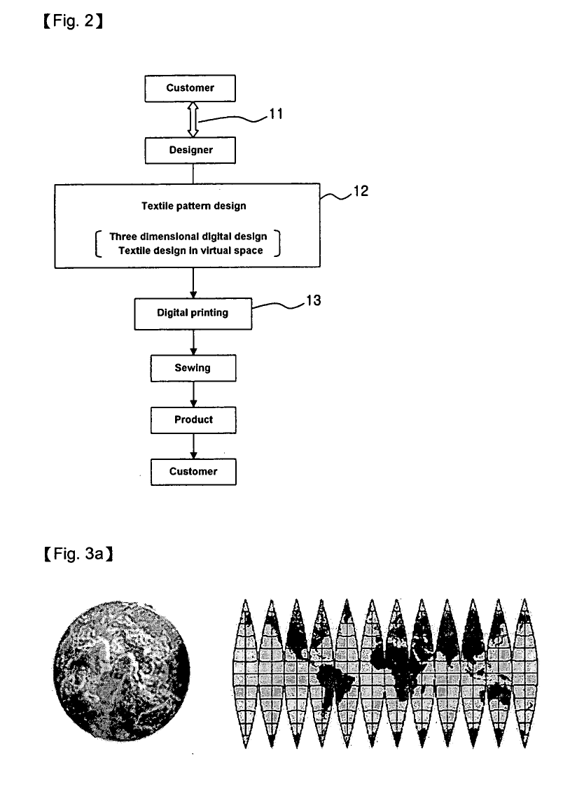

FIG. 2 is a flowchart illustrating the clothes making process in accordance with the present invention. As seen in Step 11, the customers and the textile designer can directly exchange information on the design, size, pattern, color, etc. that the customers want. Based on this information, the designer creates a motif for the textile design as basic artistic expression of the design. Then, after considering the practicability through idea development, construction and designing, a design is produced (Step 12). This process is performed on a computer in digital format. That is, the textile design is re-created in virtual space through construction and designing as digitized product, which can be re-created with new construction and design for practical use as much as one likes. Once the textile design is completed, it is printed on a cloth using a digital printer (Step 13). The cloth is cut and sewn into clothes.

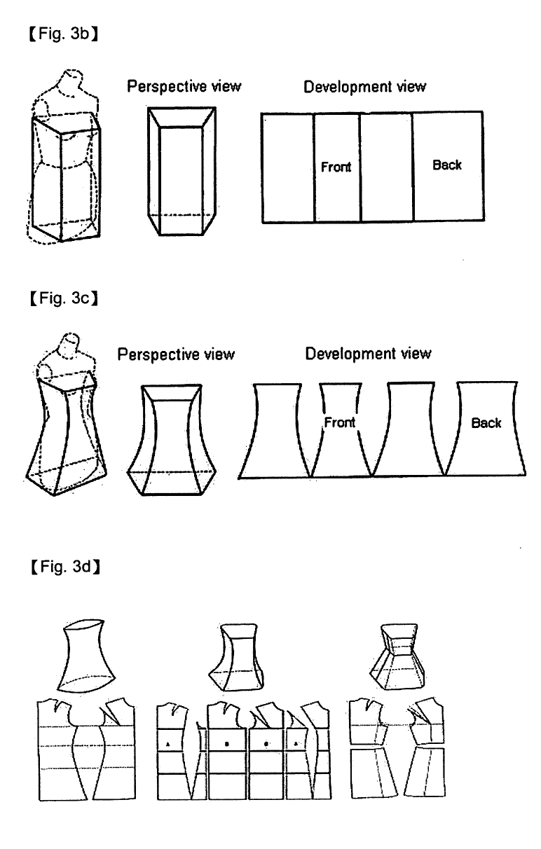

The basic principle of the three dimensional textile design process utilized in the three dimensional textile design program of the present invention will be described referring to FIG. 3.

Clothes are coverings for the human body for the purpose of protection or decoration. Clothing materials (cloth, leather, etc.) are planar ones but have long been used for clothes because they can take freely changing forms. That is, along with two dimensional planarity, they have the flexibility to be changed into three dimensional forms. The process of the transition of cloth to clothes is the transition from two dimensions to three dimensions, or from a plane to a solid body.

It is necessary to consider how the “textile design” pattern is expressed on clothes. The pattern drawn on the cloth is different from that displayed on the three dimensional clothes. It is because the pattern image changes as the cloth is cut and sewn into three dimensional forms. That is, the pattern expressed in a plane is different from the three dimensionally displayed pattern. Nevertheless, clothes have been made without considering how the pattern drawn on the cloth will be displayed in the clothes, as yet.

To solve this problem, the present invention expresses the human body in three dimensional form, as illustrated in FIG. 3, and express it on a plane considering the curvature of the human body. The method of expressing a solid body on a plane and realizing it on a computer is well known in the related art. There are a lot of such techniques, including perspective projection, conformal projection, equal area projection, etc. An adequate technique may be selected depending on the particular purpose. For example, the Universal Transverse Mercator (UTM) technique can be utilized to express the three dimensional earth relatively accurately on a two dimensional plane, as in FIG. 3a.

The three dimensional textile designing in accordance with the present invention is based on the same principle. For example, the hexahedron on the far left of FIG. 3b will be developed into the development figure on the far right of FIG. 3b. And the hexahedron of FIG. 3c will be developed into the development figure on the far right of FIG. 3c. In this manner, the hexahedron can be made similar to the human body to obtain the development figure corresponding thereto (FIG. 3d). This developed projection technique is already known. Particularly, the technique of developing a three dimensional object into two dimensions on a computer is known and utilized in graphic software programs such as 3D-MAX, etc.

The present invention is based on this principle. The three dimensional image of the clothes covering the human body is developed onto a two dimensional plane. First, the basic three dimensional pattern of each clothes type is determined. For example, a basic pattern is determined for each of the clothes type such as blouse, coat, jacket, one-piece, etc. and a two dimensional development figure is created for each basic pattern. Preferably, the data for the three dimensional image and two dimensional development figure of each basic pattern may be stored in the memory of a computer in advance. Then, when the textile designer or other computer user uses the program, he/she may make modifications of the design from the basic pattern using a variety of tools provided by the program. The three dimensional data of the modified design and the two dimensional data obtained therefrom may be stored in the memory by the computer processor. Conversely, when the user makes a modification in two dimensional design, the three dimensional data may be obtained from the modified two dimensional data and the resultant two dimensional and three dimensional data can be stored in the memory. In this manner, the basic pattern of clothes and any patterns derived therefrom may be expressed in three dimensions and two dimensions on a computer program and the user may perform textile designing freely in three dimensions or two dimensions.

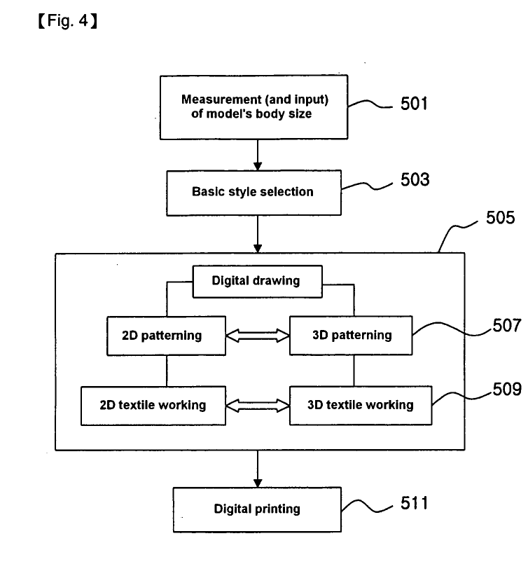

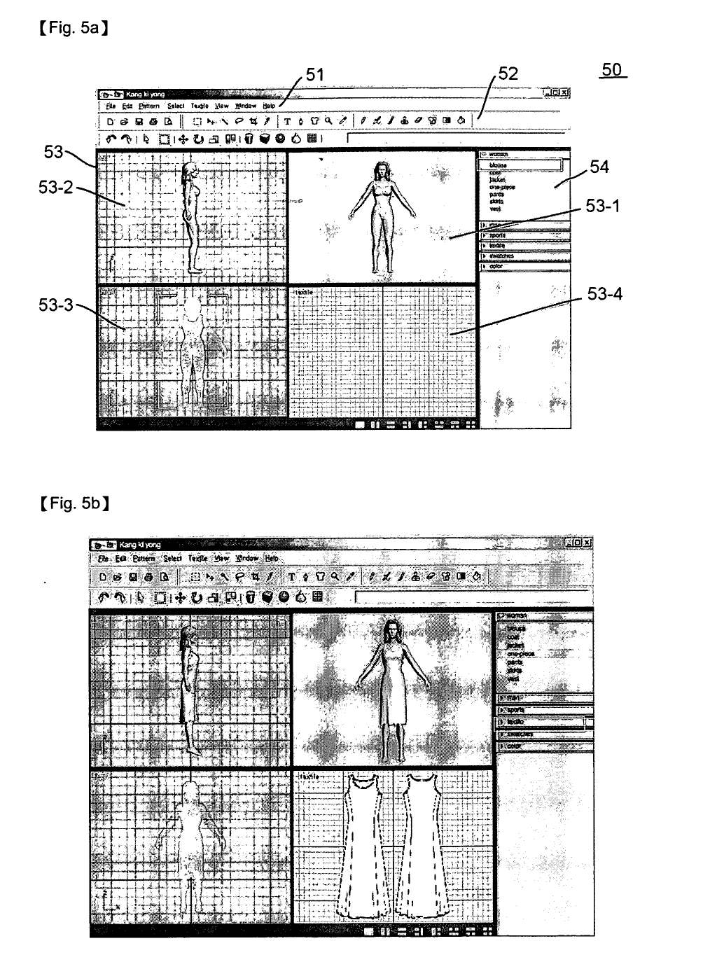

FIG. 4 illustrates the textile design process performed on a computer in accordance with the present invention and FIG. 5 illustrates the display screen of each step of the process.

When the textile design program of the present invention is executed, the execution screen shown in FIG. 5a is displayed. Various task menus are displayed on the program execution screen as in other application software. Particularly, the textile design program in accordance with the present invention preferably offers a user interface environment where the textile designing can be performed on a silhouette (external form of clothes) either in three dimensions or in two dimensions. For example, a working environment similar to that offered by such conventional 3D graphic software as 3D MAX, MAYA, etc. may be provided.

FIG. 5a shows the user interface displayed on the execution screen (50) in accordance with the present invention. A menu bar (51) and a tool bar (52) are seen at the top of the screen, a viewport (53) at the center and a command panel (54) on the right side. The menu bar (51) contains such application menus as File, Edit, Pattern, etc. as in other application software. Clicking of each menu gives a drop-down menu. Below the menu bar (51) is the tool bar (52), which contains frequently used command icons. The viewport (53) is located at the center of the execution screen. In a preferred embodiments of the present invention, the viewport (53) is composed of 4 divisional windows—one showing the three dimensional silhouette (“Perspective” window; 53-1), one showing the left-side view (“Left” window; 53-2), one showing the front view (“Front” window; 53-3) and one showing the two dimensional development view of the silhouette (“Textile” window; 53-4). The above divisional windows are only exemplary ones. For example, the viewport (53) may comprise a window showing the right-side view of the silhouette, instead of the “Left” window (53-2). Further, the number of the divisional windows may be determined at will by the user. The command panel (54) is located on the right side of the viewport (53), with the basic styles for the virtual model shown in the viewport (53) listed. As illustrated in FIG. 5a, there are such items as “woman”, “man”, “sports”, etc. When the “woman” item is clicked, for example, the sub-items for women's clothes, such as blouse, coat, jacket, one-piece, etc., are displayed.

Using the above user interface, the textile designer performs textile designing as follows.

First, the designer measures the body size of the model, including height, bust, waist, etc. (Step 501). When designing custom-made clothes for a particular customer, the body of the customer may be taken with a digital camera, etc. and the body size may be computed from the resultant digital image on a computer. Alternatively, in case the body size of a particular customer is not considered, a predetermined body size of a virtual model may be used. Or, the designer may directly input the body size.

Next, the designer selects the basic silhouette suitable for the body size (Step 503). Referring to FIG. 5, when the designer selects the “one piece” sub-item of the “woman” item from the command panel (54), for example, an image of a model wearing the one-piece is displayed on the “Perspective” window (53-1) of the viewport (53), as in FIG. 5b. The side and front views of the silhouette are displayed on the “Left” divisional window (53-2) and the “Front” divisional window (53-3), respectively. And, the two dimensional development of the silhouette is displayed on the “Textile” divisional window (53-4).

Then, the designer performs textile designing on the silhouette (Step 505). After confirming that the silhouette is one he/she likes, the designer does the patterning work of modifying the curvature or wrinkles of clothes (Step 507). During the textile designing in accordance with the present invention, the textile designer puts the pattern he/she wants on the three dimensional silhouette displayed on the “Perspective” window (53-1). The change in the curvature or wrinkles of the clothes resulting from the application of the pattern is simultaneously reflected in the “Textile” window (53-4) of the viewport (53). Or, conversely, the designer may perform the patterning work on the “Textile” window (53-4), which is reflected in the three dimensional silhouette of the “Perspective” window (53-1). In other words, the designer may either perform the 3D patterning work on the “Perspective” window (53-1) and check the 2D result in the “Textile” window (53-4) or perform the 2D patterning work on the “Textile” window (53-4) and check the 3D result in the “Perspective” window (53-1).

Subsequently, the designer draws the textile design that he/she or the particular customer who will wear the clothes wants on the silhouette (Step 509). As illustrated in FIGS. 5d to 5f, the designer may perform textile designing either on the three dimensional silhouette displayed on the “Perspective” window (53-1) or on the two dimensional development of the silhouette displayed on the “Textile” window (53-4). Thus, the designer can perform the designing more freely, changing to and from two dimensional and three dimensional working environment. That is, the designer may freely select the pattern, color, etc. that suits his/her taste. Further, size variation and location change of the design can be done freely and it can be checked immediately how the design created in two dimensions is expressed in the three dimensional clothes or, conversely, how the design created in the three dimensional silhouette is expressed in the two dimensional development figure. Accordingly, the designer may perform the designing that he/she wants more accurately and quickly.

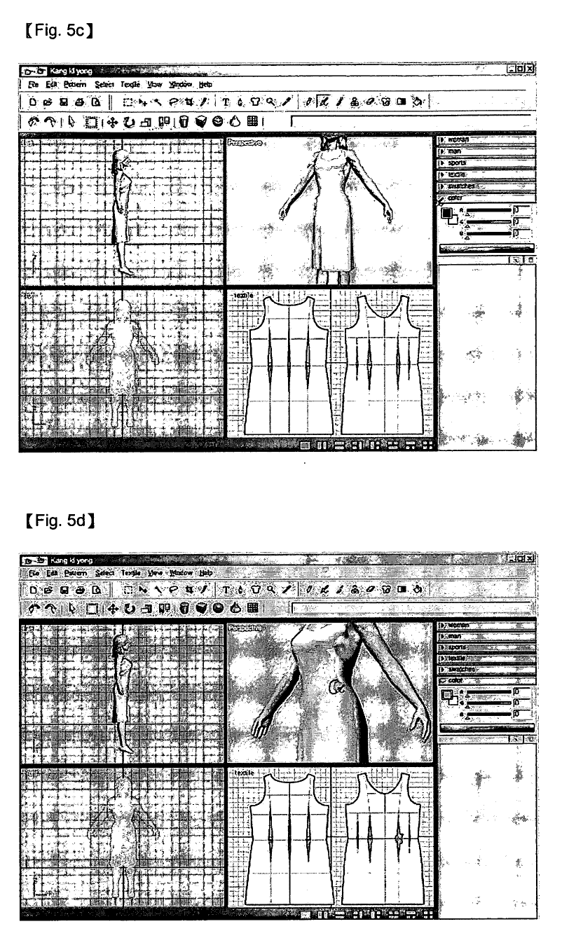

FIGS. 6 to 10 are drawings illustrating another example of clothes making using the textile design program in accordance with the present invention.

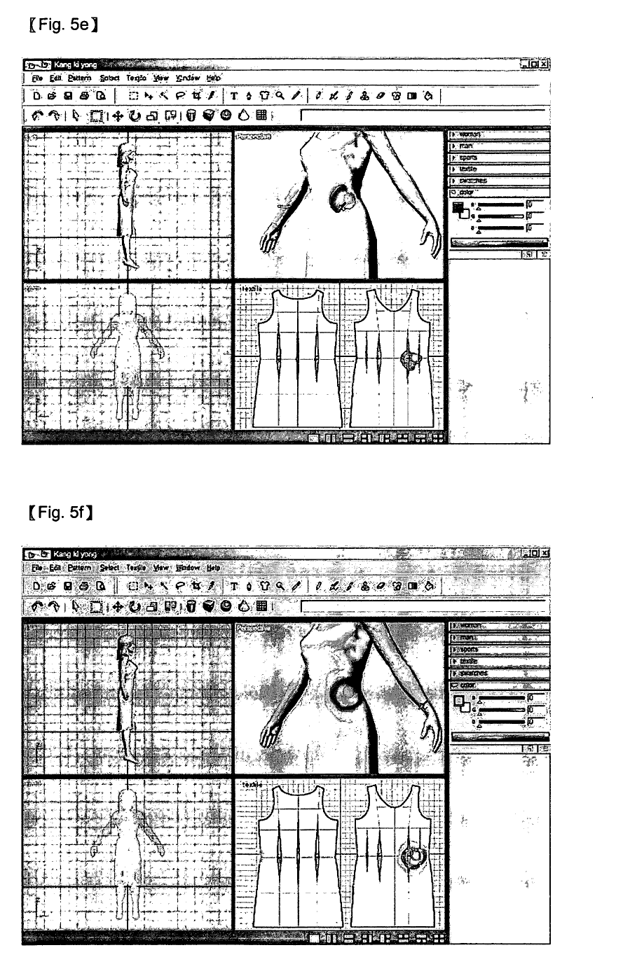

FIG. 6 shows the silhouette of the clothes that the textile designer wants to design. FIG. 7 shows the view of the textile design to be drawn on the silhouette of FIG. 6. The designer performs textile designing on a computer using the textile design program of the present invention in the manner described referring to FIG. 5. That is, the silhouette of FIG. 6 is set as basic pattern and textile designing is performed on it on the “Perspective” window (53-1) or the “Textile” window (53-4). Since the designing performed on one window is reflected on the other in 3D or 2D, the designer can complete the designing while checking the progress of his/her work.

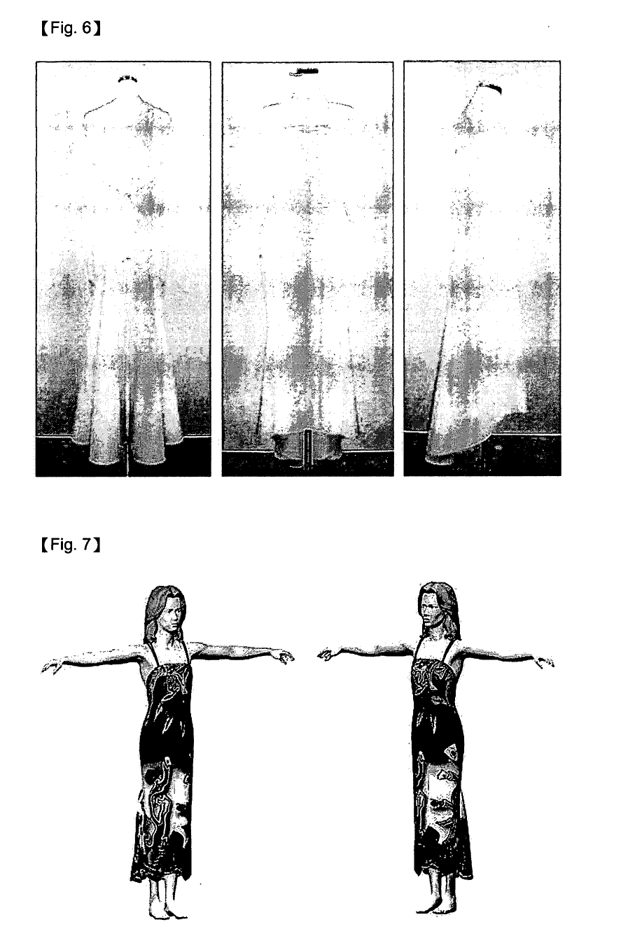

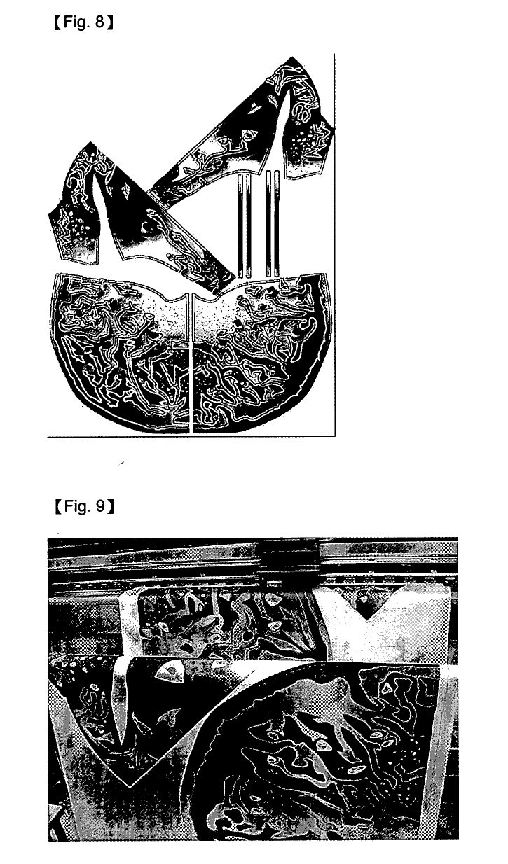

When the textile design is completed, as shown in FIG. 8, the two dimensional arrangement of the clothes is aligned for printing. The design is directly printed on cloth using a digital printer (FIG. 9). Then, the printed cloth is cut and sewn into the final clothes. In an alternative embodiment, the two dimensional arrangement as shown in FIG. 8 may be adjusted starting from the first step of pattering and textile designing. In other words, the arrangement shown in FIG. 8 may be displayed on the “Textile” window (53-4) of FIG. 5 and textile designing may be performed on that window (53-4).

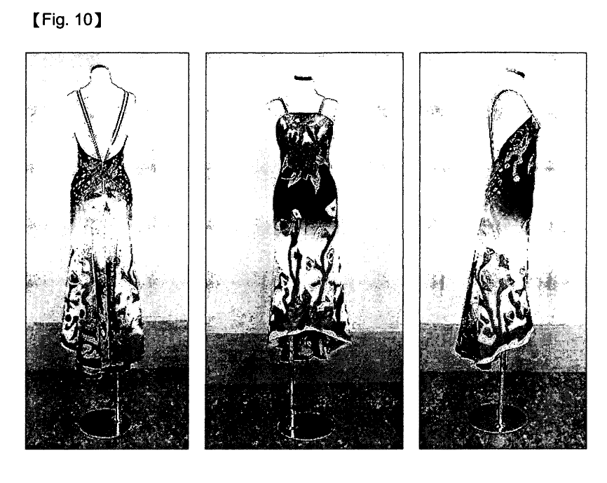

Subsequently, the textile design is printed on the clothing material, which is cut and sewn into the final clothes as seen in FIG. 10.

### INDUSTRIAL APPLICABILITY

As apparent from the above description, the present invention can solve the problem of the pattern or color designed by the textile designer on two dimensional cloth being deformed in three dimensional clothes. Using the textile design program of the present invention, the textile designer may perform designing on the three dimensional clothes form, which is automatically expressed in two dimensions on a computer, making it possible to print the design and make clothes through cutting and sewing. Also, when the textile designing is performed in two dimensions, the design can immediately check how the design is expressed in three dimensional clothes.

This advantage the relationship between the customers who buy clothes, the textile designers who design the patterns and the fashion designers who make the clothes closer. The customer or the fashion designer may directly order the clothes pattern and textile design he/she wants to the textile designer and the textile designer may perform 3D or 2D patterning and textile designing using the program in accordance with the present invention. Consequently, the process from the textile designing of the ordered clothes pattern to the printing of the completed design on cloth can be performed at once. That is, the present invention provides a textile design system that can directly reflect the intentions and tastes of textile designers, fashion designers and customers.

Accordingly, the textile design system of the present invention can bring a revolutionary effect on the textile design industry since it can be applied not only to the mass production of ready-made clothes but also to the making of a single suit that a customer wants.

Those skilled in the art will appreciate that the concepts and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the present invention as set forth in the appended claims.

1. A method for textile design of clothes using a computer, which comprises the steps of:
inputting the body size of a model into a computer;
selecting a basic silhouette suitable for the body size;
modifying the selected silhouette through pattering; and
drawing a textile design on the silhouette,
wherein a display screen of the computer displays at least a first divisional window which displays the three dimensional image of the silhouette and a second divisional window which displays the two dimensional development image of the silhouette,
the step of pattering and the step of textile design drawing are performed using one of the first divisional window and the second divisional window, and
the three dimensional image data of the silhouette displayed on the first divisional window and the two dimensional image data of the silhouette displayed on the second divisional window are linked to each other, so that the change of one of the three dimensional or two dimensional image data is reflected on the other data and results in the display of the modified image on the corresponding divisional window.

2. The method for textile design as set forth in claim 1, wherein the step of inputting the body size into a computer comprises the step of inputting a digital image data of a human body and computing the body size from the image data.

3. A computer-readable storage medium storing a textile design program for textile design of clothes using a computer, wherein the textile design program is executed by the steps comprising:
inputting the body size of a model into a computer;
selecting a basic silhouette suitable for the body size;
modifying the selected silhouette through pattering in response to a user's command input; and
drawing a textile design on the silhouette in response to the user's command input,
wherein a display screen of the computer displays at least a first divisional window which displays the three dimensional image of the silhouette and a second divisional window which displays the two dimensional development image of the silhouette and the user's command input is input through one of the first divisional window and the second divisional window and
the three dimensional image data of the silhouette displayed on the first divisional window and the two dimensional image data of the silhouette displayed on the second divisional window are linked to each other, so that the change of one of the three dimensional or two dimensional image data is reflected on the other data and results in the display of the modified image on the corresponding divisional window.

4. The computer-readable storage medium storing a textile design program as set forth in claim 3, wherein the step of inputting the body size into a computer comprises the step of inputting a digital image data of a human body and computing the body size from the image data.
